(19) United States
(12) Patent Application Publication
(10) Pub. No.: US 2018/0339494 A1
(43) Pub. Date: Nov. 29, 2018

(54) COMPOSITE COMPONENT

(71) Applicant: NIHON PLAST CO., LTD., Fujinomiya-shi (JP)

(72) Inventor: Ryuta SUZUKI, Fujinomiya-Shi (JP)

(73) Assignee: NIHON PLAST CO., LTD.

(21) Appl. No.: 15/990,451

(22) Filed: May 25, 2018

(30) Foreign Application Priority Data
May 26, 2017 (JP) 2017-104938
Apr. 17, 2018 (JP) 2018-079033

(51) Int. Cl. B32B 15/08; B32B 3/30

(52) U.S. Cl. CPC B32B 15/08; B62D 29/001; B32B 3/30

(57) ABSTRACT

A composite component is a composite component including a metal portion formed of a metal and a resin portion formed of a resin. The metal portion includes: a main body portion, a plurality of hole portions provided along any one of directions separating from each other and directions parallel to each other in the main body portion from outside toward inside, and a connecting portion configured to connect the hole portions to each other inside the main body portion. The resin portion includes: a cover portion covering the main body portion in a position corresponding to at least the hole portions, and a joint portion provided in a protruding manner from the cover portion to be positioned inside the plurality of hole portions, the joint portion being continuous in a position of the connecting portion.

### CROSS REFERENCE TO RELATED APPLICATION

This application is based upon and claims the benefit of priority from the prior Japanese Patent Application No. 2017-104938 (filing date: May 26, 2017), and Japanese Patent Application No. 2018-079033 (filing date: Apr. 17, 2018), the entire contents of which are incorporated herein by reference.

### BACKGROUND

### Technical Field

The present invention relates to a composite component including a metal portion formed of a metal and a resin portion formed of a resin.

### Related Art

Conventionally, as a metallic structure used for a vehicle such as an automobile, a composite component a part of which is made of a synthetic resin in order to reduce weight is sometimes used. In the case of such a composite component, it is required to firmly join the metal portion and the resin portion.

For example, a configuration in which forming a plurality of hole portions on a front surface of the metal portion, and inserting a part of the resin portion into these hole portions joins the metal portion and the resin portion is known. In this configuration, forming the hole portions to be elongated and forming the minimum inner diameter portion of these hole portions in the position between the opening and the bottom portion produces an anchor action (see JP 2014-166693 A (page 5-6, FIGS. 1A to 1C)).

### SUMMARY

However, in the case of the above-described structure, the joining force between the metal portion and the resin portion is due solely to the anchor action caused by the anchor shape of each hole portion with limited effects. A structure that is more stable and can obtain a higher joining strength is required.

In this regard, although a configuration in which a groove group including a plurality of grooves is formed and a part of the resin portion is made to enter this groove group is also conceivable, a structure capable of obtaining a larger anchor action is required.

The present invention is made in view of the above problems, and an object of the present invention is to provide a composite component in which joining strength between the metal portion and the resin portion is improved.

A composite component according to one aspect of the present invention is a composite component including a metal portion formed of a metal and a resin portion formed of a resin. The metal portion includes: a main body portion, a plurality of hole portions provided along any one of directions separating from each other or directions parallel to each other in the main body portion from outside toward inside, and a connecting portion configured to connect the hole portions to each other inside the main body portion. The resin portion includes: a cover portion covering the main body portion in a position corresponding to at least the hole portions, and a joint portion provided in a protruding manner from the cover portion to be positioned inside the plurality of hole portions, the joint portion being continuous in a position of the connecting portion.

The hole portions may be arranged in rows, the connecting portion may connect hole portions in rows to each other inside the main body portion, and the joint portion may be continuous in a position of the connecting portion.

The plurality of hole portions may be arranged in a plurality of rows, the connecting portion may connect hole portions in each row to each other and hole portions in adjacent rows to each other inside the main body portion, and the joint portion may be continuous in a position of the connecting portion.

According to the composite component according to one aspect of the present invention, it is possible to provide a composite component in which the joining strength between the metal portion and the resin portion is stably improved.

In the case where the hole portions arranged in rows are connected to each other inside the main body portion with the connecting portion, since the joint portion continuous in a position of the connecting portion can be made continuous over a plurality of hole portions in rows, the joining strength between the metal portion and the resin portion can be further improved.

In the case where the hole portions in each row and the hole portions in adjacent rows of the hole portions arranged in a plurality of rows are connected to each other inside the main body portion with the connecting portion, since the joint portion continuous in a position of the connecting portion can be made continuous between a plurality of hole portions in rows and hole portions in adjacent rows, the joining strength between the metal portion and the resin portion can be further improved.

### BRIEF DESCRIPTION OF DRAWINGS

FIG. 1A is a cross-sectional view schematically showing a part of a composite component according to a first embodiment of the present invention;

FIG. 1B is a plan view schematically showing a part of the composite component described in FIG. 1A;

FIG. 2A is a cross-sectional view taken along the line IIA-IIA in FIG. 1A;

FIG. 2B is a cross-sectional view taken along the line IIB-IIB in FIG. 1A;

FIG. 2C is a cross-sectional view taken along the line IIC-IIC in FIG. 1A;

FIG. 3A is a cross-sectional view taken along the line IIIA-IIIA in FIG. 1B;

FIG. 3B is a cross-sectional view taken along the line IIIB-IIIB in FIG. 1B;

FIG. 3C is a cross-sectional view taken along the line IIIC-IIIC in FIG. 1B;

FIG. 4 is a cross-sectional view schematically showing a shape of a part of the composite component described above;

FIG. 5 is a cross-sectional view schematically showing a metal portion of the composite component described above;

FIG. 6A is end view schematically showing a manufacturing process of a hole portion of a manufacturing method of the composite component described;

FIG. 6B is end view schematically showing a manufacturing process of a hole portion of a manufacturing method of the composite component described;

FIG. 6C is end view schematically showing a manufacturing process of a hole portion of a manufacturing method of the composite component described;

FIG. 6D is end view schematically showing a manufacturing process of a hole portion of a manufacturing method of the composite component described;

FIG. 6E is end view schematically showing a manufacturing process of a hole portion of a manufacturing method of the composite component described;

FIG. 7 is a cross-sectional view schematically showing a comparative example of the composite component described above;

FIG. 8 is a plan view showing a part of a composite component according to a second embodiment of the present invention; and

FIG. 9 is a plan view showing a part of a composite component according to a third embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

In the following, the configuration of a first embodiment of the present invention will be described with reference to the drawings.

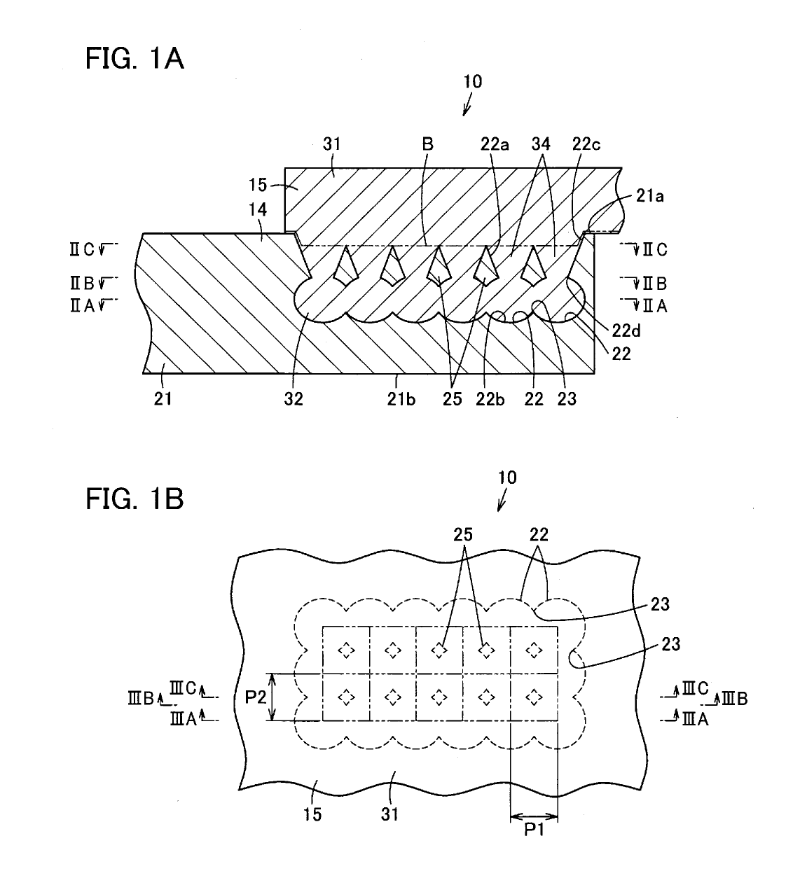

In FIGS. 1A and 1B, the composite component 10 is for a vehicle such as an automobile. The composite component 10 is suitably used as an optional vehicle structure such as a steering hanger beam (steering member) being a cockpit module component, a cross car beam, a suspension arm, or a strut tower bar.

Then, the composite component 10 integrally includes a metal portion 14 and a resin component (synthetic resin component) 15.

The metal portion 14 is formed of a metal such as iron (steel), aluminum, or magnesium, an alloy, or the like. The metal portion 14 can also be referred to as a composite component main body, and is, for example, a main part of the composite component 10. The metal portion 14 includes a main body portion 21. In addition, the metal portion 14 includes a plurality of hole portions 22. Furthermore, the metal portion 14 includes a connecting portion 23 to be described below. Then, for clarity of description, only a part of the metal portion 14 is illustrated, and the illustration of other portions will be omitted.

The main body portion 21 is formed in a plate shape at least a part of which has a front surface 21a and a back surface 21b. The front surface 21a of the main body portion 21 is a contact surface of the metal portion 14 with the resin portion 15 and is a non-joint surface. It should be noted that, for example, the main body portion 21 may have a plate shape as a whole, or may have a plate shape in the portion to be joined to the resin portion 15 and does not need to have a plate shape in the other portion. In addition, the plate shape includes not only a flat plate shape but also a curved surface plate shape such as a cylindrical shape.

Each hole portion 22 shown in FIGS. 1A and 1B, and the like is formed on the front surface 21a of the main body portion 21 as a recess not penetrating to the back surface 21b of the main body portion 21. Each hole portion 22 is formed, for example, by irradiating the front surface 21a of the main body portion 21 with a laser beam (pulsed laser). Each hole portion 22 has substantially the same shape. For example, each hole portion 22 includes a thin hole portion 22a being a hole base end portion positioned on the front surface 21a side of the main body portion 21, and an enlarged hole portion 22b being a hole tip portion (hole bottom portion) continuous with the tip portion of the thin hole portion 22a, and is formed in a longitudinal shape along the thickness direction of the main body portion 21. In addition, each hole portion 22 has a circular cross section (including a substantially circular shape) orthogonal to the thickness direction of the main body portion 21, for example.

The thin hole portion 22a includes an opening 22c for opening toward the front surface 21a in the base end portion, and is formed in a cylindrical surface shape gradually decreasing in diameter to the tip end, that is, in a truncated conical surface shape from the opening 22c toward the inside being the back surface 21b side of the main body portion 21, that is, toward the enlarged hole portion 22b. In addition, the enlarged hole portion 22b is formed to bulge with respect to the tip portion of the thin hole portion 22a. In the present embodiment, the enlarged hole portion 22b is formed in, for example, a spherical shape (including a substantially spherical shape). Therefore, in the thickness direction of the main body portion 21, the position of the opening 22c of each hole portion 22 is in the position whose corresponding plane has the largest diameter dimension with the largest cross sectional area, and the position where the thin hole portion 22a and the enlarged hole portion 22b are continuous is the constricted portion 22d having the smallest cross sectional area, that is, the smallest diameter dimension. That is, in the thickness direction of the main body portion 21, each hole portion 22 includes an opening 22c having the largest cross-sectional area on the front surface 21a side of the main body portion 21, and a constricted portion 22d having the smallest cross-sectional area between the front surface 21a side end portion and the hole tip portion of the main body portion 21. In addition, the enlarged hole portion 22b is, for example, formed to have a smaller length (depth) than the thin hole portion 22a.

In addition, each hole portion 22 is linearly formed along the predetermined direction from the opening 22c to the tip of the enlarged hole portion 22b. In the present embodiment, the respective hole portions 22 are formed along a direction parallel to each other. That is, the longitudinal directions (depth directions) of the respective hole portions 22 are parallel to each other. In the present embodiment, the longitudinal direction (depth direction) of each hole portion 22 is, for example, the thickness direction of the main body portion 21, in other words, the direction perpendicular to the front surface 21a (normal direction of the front surface 21a).

Furthermore, the respective hole portions 22 are arranged at predetermined pitches P1 in rows along a predetermined one direction (left-right direction in FIGS. 1A and 1B). In addition, the respective hole portions 22 are arranged at predetermined pitches P2 in a predetermined other direction (vertical direction in FIG. 1B) in which these rows cross the predetermined one direction. Therefore, the hole portions 22 are arranged in a lattice shape as a whole. In the present embodiment, the respective rows of the hole portions 22 are not displaced in one direction along these rows, and the hole portions 22 in adjacent rows are arranged along the other direction. Therefore, the centers of the respective hole portions 22 are arranged in a rectangular lattice shape (tetragonal lattice shape).

The pitch P1 is set to be, for example, not more than the diameter dimension D of the opening 22c of the hole portion 22. In addition, the pitch P1 is, for example, set to be larger than the radius dimension of the opening 22c of the hole portion 22. Therefore, adjacent hole portions 22 and 22 in each row are continuous with each other in the outer edge portions of the openings 22c and 22c. As a result, the metal portion 14 forms an imaginary boundary surface B recessed from the position of the front surface 21a toward the back surface 21b of the main body portion 21 between the metal portion 14 and the resin portion 15 in the position of each row of the hole portion 22 (imaginary line in FIG. 1A and FIG. 5).

The pitch P2 may be the same as the pitch P1 or may be different from the pitch P1, for example. In the present embodiment, the pitch P2 is set to be equal to (including substantially equal to) the pitch P1, for example. Therefore, the hole portions 22 and 22 of the adjacent rows are continuous with each other in the outer edge portions of the openings 22c and 22c. As a result, the metal portion 14 forms an imaginary boundary surface B recessed from the position of the front surface 21a toward the back surface 21b of the main body portion 21 between the metal portion 14 and the resin portion 15 in at least a part of the region where the hole portion 22 is formed, in the entire region where the hole portion 22 is formed in the present embodiment (imaginary line in FIG. 1A and FIG. 5). That is, at least a part of the imaginary boundary surface B is arranged in a position whose corresponding plane does not coincide with the front surface 21a of the main body portion 21 being the non-joint contact surface, in other words, in a position whose corresponding plane is not coplanar with the front surface 21a. Specifically, the imaginary boundary surface B is arranged in a position where at least a part of the imaginary boundary surface B enters toward the back surface 21b with respect to the front surface 21a of the main body portion 21.

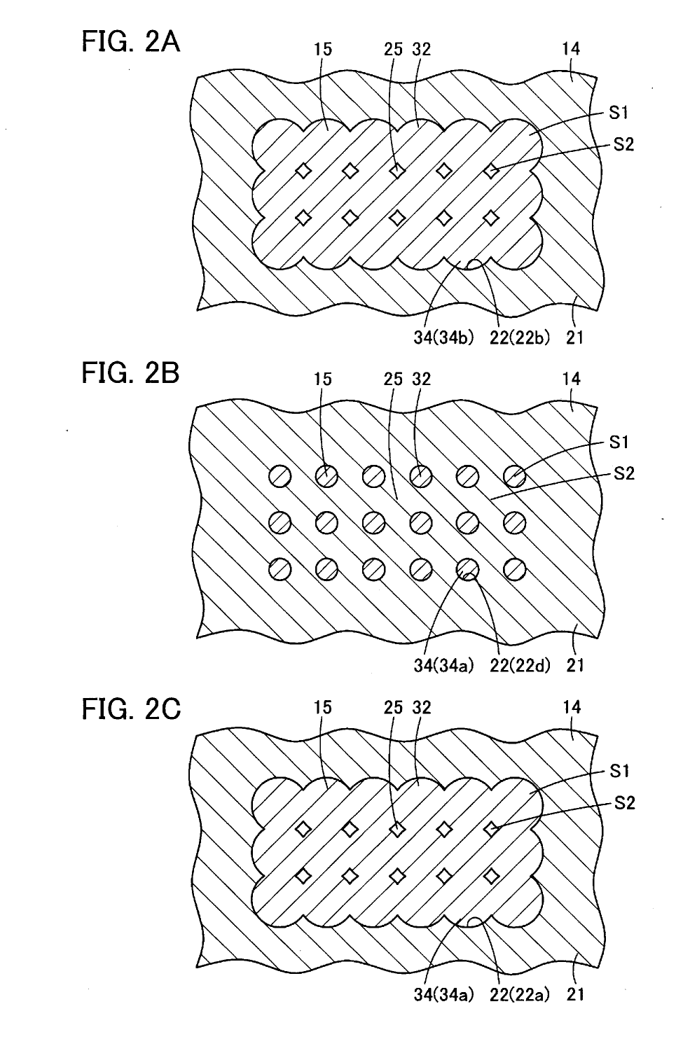

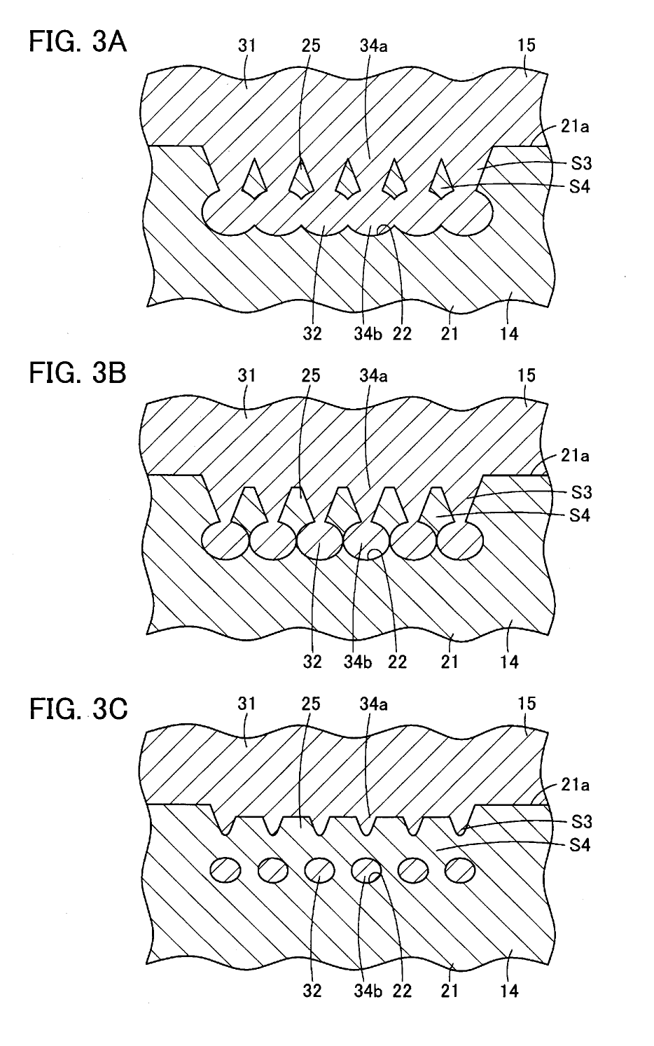

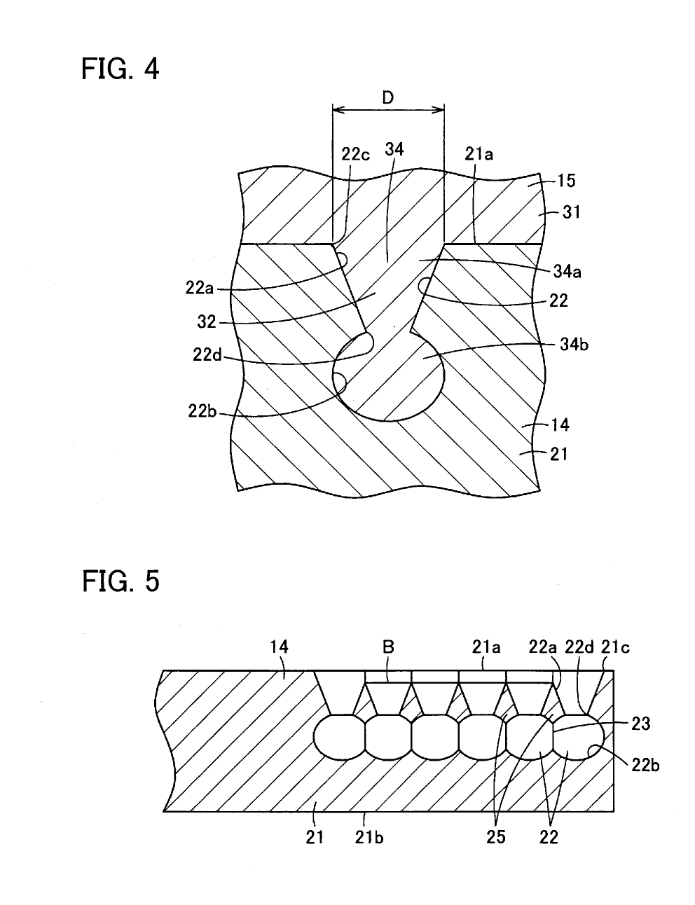

The connecting portion 23 is formed as what is called an internal tunnel (lateral hole) that connects a plurality of hole portions 22 to each other inside the main body portion 21. In the present embodiment, the connecting portion 23 is formed by connecting a plurality of hole portions 22 in rows in one direction to each other and by connecting the hole portions 22 in adjacent rows to each other. Therefore, in the present embodiment, the connecting portion 23 connects the plurality of hole portions 22 in a tetragonal lattice shape (imaginary line in FIG. 1B). The connecting portion 23 connects the hole portions 22 and 22 in the positions of the enlarged hole portions 22b and 22b. That is, the hole portions 22 and 22 are separated from each other in a position (shallow position) on the opening 22c side of the connecting portion 23. That is, the hole portions 22 and 22 are separated from each other in a position between the opening 22c and the connecting portion 23, that is, in a position including the constricted portion 22d (minimum diameter position). Therefore, in the metal portion 14, a non-connecting portion 25 which is a metal portion side anchor portion as a metal portion side protruding portion and in which a plurality of hole portions 22 are not connected to each other is formed in a position between the opening 22c and the connecting portion 23 between the hole portions 22 and 22. That is, the metal portion 14 includes the non-connecting portion 25. The non-connecting portion 25 is continuous with the main body portion 21 in a position corresponding to the constricted portion 22d, and as the position moves away from the constricted portion 22d, the non-connecting portion 25 enters between the hole portions 22 and 22 to be formed to be separated from the main body portion 21. In the non-connecting portion 25, the cross-sectional area continuously varies in the longitudinal direction (depth direction) of the hole portion 22 and in a direction crossing (orthogonal to) the longitudinal direction (FIGS. 2A to 2C and FIGS. 3A to 3C). The connecting portion 23 is positioned behind the non-connecting portion 25 (the inner side of the main body portion 21). In addition, an end portion on the outer side of the main body portion 21 being on the opposite side of the non-connecting portion 25 from the connecting portion 23 forms an imaginary boundary surface B.

The resin portion 15 is formed of a thermoplastic synthetic resin. The resin portion 15 covers at least a part of the front surface 21a of the main body portion 21, and in this embodiment, covers a part of the front surface 21a. The resin portion 15 integrally includes, for example, a cover portion 31 and an anchor portion 32 as a joint portion.

The cover portion 31 is a portion that covers the front surface 21a of the main body portion 21 in a position corresponding to at least the hole portion 22. In the present embodiment, the cover portion 31 covers the front surface 21a of the main body portion 21 in the position corresponding to the hole portion 22 and the position around the hole portion 22, and a part of the cover portion 31 extends toward the main body portion 21. In addition, the cover portion 31 is formed in a plate shape. The cover portion 31 may have a plate shape as a whole, or may have a plate shape in the portion to be joined to the front surface 21a of the main body portion 21 of the metal portion 14 and does not need to have a plate shape in the other portion, for example. In addition, the plate shape includes not only a flat plate shape but also a curved surface plate shape such as a cylindrical shape.

The anchor portion 32 protrudes from the cover portion 31 toward the metal portion 14 (the main body portion 21) and is positioned inside the plurality of hole portions 22. That is, the anchor portion 32 is formed so that a plurality of protruding portions 34 positioned inside each of the hole portions 22 are continuous with each other in the position of the connecting portion 23. In other words, the individual protruding portions 34 are not independent of each other, and are connected to each other to be united in the position of the connecting portion 23, that is, in a position close to the tip portion of the anchor portion 32. Therefore, in the anchor portion 32, the protruding portions 34 and 34 are connected to each other behind the non-connecting portion 25 of the metal portion 14. In other words, a part of the anchor portion 32 enters behind the non-connecting portion 25 of the metal portion 14.

The protruding portions 34 have shapes corresponding to the respective hole portions 22. That is, each protruding portion 34 integrally includes a shaft portion 34a being a protrusion base end portion positioned in the thin hole portion 22a and an enlarged portion 34b being a protrusion tip portion positioned in the enlarged hole portion 22b. The shaft portion 34a of each protruding portion 34 is formed in, for example, a cylindrical shape, and is gradually reduced in diameter from the cover portion 31 side being the base end portion to the tip portion inside the main body portion 21, that is, toward the enlarged portion 34b. That is, the shaft portion 34a is formed in a truncated conical shape. In addition, the enlarged portion 34b is formed to bulge with respect to the tip portion of the shaft portion 34a. In the present embodiment, the enlarged portion 34b is formed, for example, in a spherical shape. Then, the respective protruding portions 34 are connected to each other via the connecting portion 23 in the position of the enlarged portion 34b.

In addition, the magnitude relation between the cross-sectional area S1 of the anchor portion 32 (each protruding portion 34) and the cross-sectional area S2 of the non-connecting portion 25 in the plane crossing (orthogonal to) the longitudinal direction of the protruding portion 34 being the depth direction of the hole portion 22 changes alternately along the longitudinal direction from the enlarged hole portion 22b to the thin hole portion 22a of the hole portion 22 (FIGS. 2A to 2C). That is, in the position of the enlarged hole portion 22b of the hole portion 22, the cross-sectional area S1 of the anchor portion 32 is larger than the cross-sectional area S2 of the non-connecting portion 25, in the position of the constricted portion 22d, the cross-sectional area S2 of the non-connecting portion 25 is larger than the cross-sectional area S1 of the anchor portion 32, and in the position of the thin hole portion 22a, the cross-sectional area S1 of the anchor portion 32 is larger than the cross-sectional area S2 of the non-connecting portion 25. In other words, as the position approaches the constricted portion 22d, the cross-sectional area S1 of the anchor portion 32 (hole portion 22) continuously changes so as to gradually decrease, and the cross-sectional area S2 of the non-connecting portion 25 continuously changes so as to gradually increase. Therefore, in the position of the constricted portion 22d, the cross-sectional area S1 of the anchor portion 32 (hole portion 22) reaches the minimum and the cross-sectional area S2 of the non-connecting portion 25 reaches the maximum.

Similarly, the magnitude relation between the cross-sectional area S3 of the anchor portion 32 (each protruding portion 34) and the cross-sectional area S4 of the non-connecting portion 25 in the plane along the longitudinal direction of the protruding portion 34 being the depth direction of the hole portion 22 changes alternately along the radial direction of the hole portion 22 (protruding portion 34) (FIGS. 3A to 3C). That is, in the center position of the hole portion 22, the cross-sectional area S3 of the anchor portion 32 is larger than the cross-sectional area S4 of the non-connecting portion 25, and in the position between adjacent hole portions 22 and 22, the cross-sectional area S4 of the non-connecting portion 25 is larger than the cross-sectional area S3 of the anchor portion 32. In other words, as the position approaches the central portion of the adjacent hole portions 22 and 22, the cross-sectional area S3 of the anchor portion 32 (hole portion 22) continuously changes so as to gradually decrease, and the cross-sectional area S4 of the non-connecting portion 25 continuously changes so as to gradually increase. Therefore, in the central portion of the adjacent hole portions 22 and 22, the cross-sectional area S3 of the anchor portion 32 (hole portion 22) reaches the minimum and the cross-sectional area S4 of the non-connecting portion 25 reaches the maximum.

Next, a method for manufacturing the composite component 10 of the first embodiment will be described.

As an outline, in the metal portion 14, molding a main body portion 21 without hole portions 22, irradiating the main body portion 21 with a laser beam (pulsed laser) L to form a hole portion 22, for example, by using an irradiation device (not shown), and placing the metal portion 14 in a cavity of a forming die (not shown) and insert-molding a resin portion 15 with a synthetic resin forms a composite component 10 integrally including the metal portion 14 and the resin portion 15.

The irradiation device includes an irradiation device main body that applies the laser beam L and a reflector that reflects the laser beam L applied from the irradiation device main body. The irradiation device main body is basically fixed in a position where the emitting unit of the laser beam L is directed to the reflector, and the reflector is rotatably provided. Then, the irradiation device moves the irradiation position of the laser beam L on the front surface 21a of the metal portion 14 (main body portion 21) with the rotation of the reflector, and moves the metal portion 14 as necessary, thereby forming a plurality of hole portions 22 in different positions.

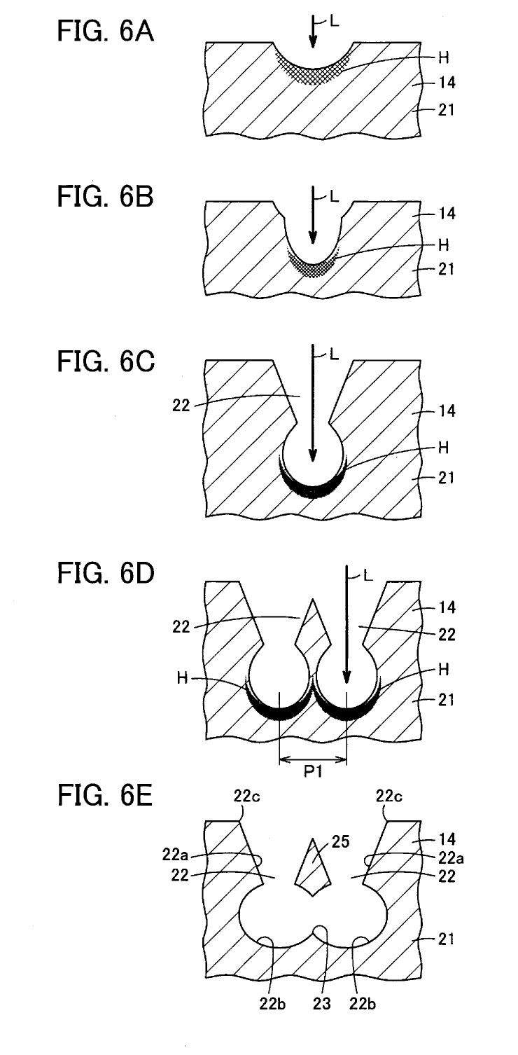

The method for manufacturing the composite component 10 will be described in more detail. Repeatedly irradiating the same position on the front surface 21a of the metal portion 14 (the main body portion 21) with the laser beam L a plurality of times, for example, ten and several times, by using the irradiation device causes the main body portion 21 to be gradually recessed, and the hole portion 22 is formed. For example, FIG. 6A is a schematic view of a part of the metal portion 14 when the laser beam L is applied 1 to 8 times, FIG. 6B is a schematic view of a part of the metal portion 14 when the laser beam L is applied 9 to 12 times, and FIG. 6C shows a schematic view of a part of the metal portion 14 when the laser beam L is applied 13 to 15 times. At this time, inside the metal portion 14, the temperature gradually rises in the position of the bottom portion of the hole portion 22 due to repeated heat input (schematically shown by symbol H in the drawing). It should be noted that the number of irradiation times of the laser beam L to be required varies depending on the material of the metal portion 14.

Thus, continuously forming a plurality of hole portions 22 for each pitch P1 (FIG. 6D) causes the heat input into adjacent hole portions 22 and 22 to affect each other, causes the connecting portion 23 to be formed in the position of the enlarged hole portions 22b and 22b, and causes the hole portions 22 and 22 to be connected to each other (FIG. 6E).

Similarly, continuously forming the rows of a plurality of hole portions 22 for each pitch P2 causes the heat input into hole portions 22 and 22 of adjacent rows to affect each other, causes the connecting portion 23 to be formed in the position of the enlarged hole portions 22b and 22b, and causes the hole portions 22 and 22 to be connected to each other.

That is, the connecting portion 23 does not include a separate step for forming the connecting portion 23, but is automatically formed simply by adjacently and continuously forming a plurality of hole portions 22.

In addition, in the metal portion 14 (the main body portion 21), a portion between the adjacent hole portions 22 and 22 remains as a protruding non-connecting portion 25.

Thereafter, the resin portion 15 is injection-molded so as to cover a part of the main body portion 21 including the position of the hole portion 22. At this time, since the adjacent hole portions 22 are connected to each other by the connecting portion 23, when the hole portions 22 are sequentially filled with the molten resin, for example, along the row, the air in the hole portion 22 is pushed out from the connecting portion 23 to the adjacent hole portion 22, so that bubbles hardly remain in the hole portion 22, and the molten resin can be reliably filled in the hole portion 22. Then, cooling and solidifying the molten resin forms the resin portion 15 integrally including the cover portion 31 and the anchor portion 32.

As described above, in the composite component 10 according to the first embodiment, a plurality of hole portions 22 provided along the parallel direction to each other from the outside toward the inside the main body portion 21 of the metal portion 14 are connected to each other by the connecting portion 23. Then, providing in a protruding manner the anchor portion 32 which is positioned inside the plurality of hole portions 22 in the cover portion 31 of the resin portion 15 and is continuous in the position of the connecting portion 23 increases the anchor effect on the tensile force acting in the direction in which the resin portion 15 separates from the metal portion 14 (upward force in FIG. 1A), so that a large anchor effect can be obtained.

The anchor portion 32 of the resin portion 15 enters behind (the inner side) the metal portion 14 being the basis of the joining between the metal portion 14 and the resin portion 15, and the resin portion 15 is formed in an integrated structure continuous behind the metal portion 14 (the non-connecting portion 25), whereby it is difficult for the anchor portion 32 to be removed from the hole portion 22, and the anchoring effect on the tensile force in the direction in which the resin portion 15 separates from the metal portion 14 increases.

In particular, since the hole portion 22 is provided with a connecting portion 23 in a position on the inner side of the main body portion 21 with respect to the constricted portion 22d being the minimum diameter dimension position, the enlarged portion 34b of the protruding portion 34 positioned in the enlarged hole portion 22b of the hole portion 22 of the anchor portion 32 has a larger cross-sectional area perpendicular to the direction crossing (orthogonal to) the longitudinal direction of the hole portion 22, that is, the tensile force direction, than the constricted portion 22d (FIGS. 2A and 2B), and it is difficult for the anchor portion 32 to be removed from the hole portion 22.

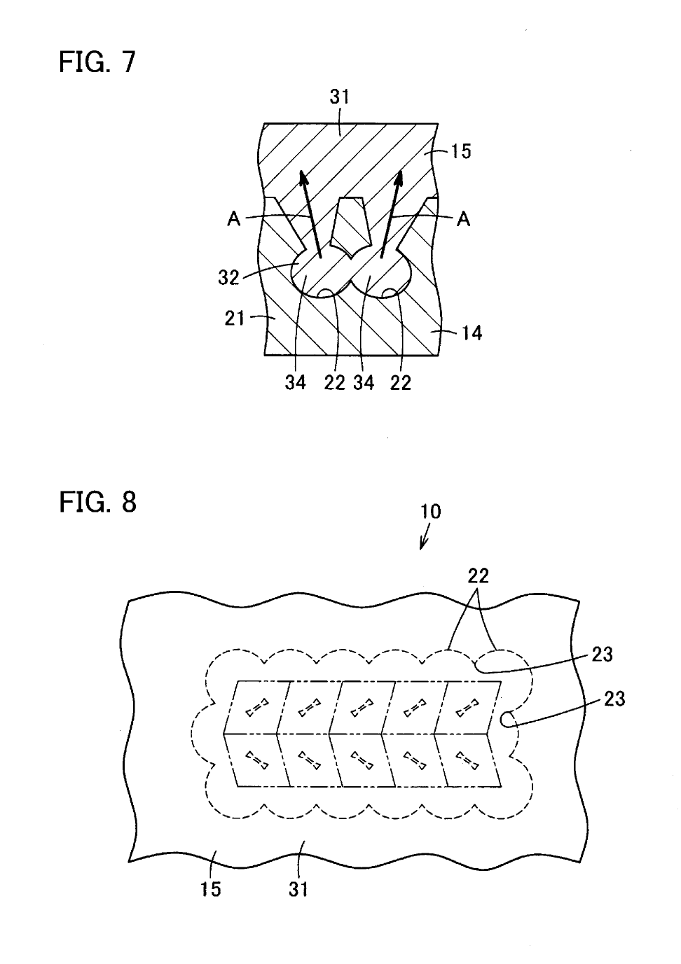

In addition, in the case of a comparative example in which if the hole portions 22 and 22 are provided along the approaching directions to each other from the outside toward the inside in the main body portion 21 of the metal portion 14 (FIG. 7), the tensile forces in directions in which the resin portion 15 separates from the metal portion 14 act on the anchor portion 32 filled in the hole portion 22 in directions in which the protruding portions 34 and 34 continuous with each other are separated from each other (see an arrow A in FIG. 7), and it is difficult to obtain sufficient joining strength. On the other hand, in the present embodiment, since the hole portions 22 are provided along directions parallel to each other, no force acts on the anchor portion 32 filled in the hole portion 22 in the directions in which the protruding portions 34 and 34 are separated from each other, and the anchoring effect on the tensile force increases.

Furthermore, the front surface 21a which is the non-joining contact surface between the metal portion 14 and the resin portion 15 and the imaginary boundary surface B at the joint surface between the metal portion 14 and the resin portion 15 do not coincide with each other, and the cross-sectional area increases with respect to the external force in the shearing direction (lateral direction in FIG. 1A). In other words, the composite component 10 according to the first embodiment has a joining strength obtained by shear strength with respect to the area of the entire surface having steps from the front surface 21a to the imaginary boundary surface B, rather than the joining strength obtained by the shear strength per diameter dimension of the hole portion 22. Therefore, shearing (peeling) between the metal portion 14 and the resin portion 15 is unlikely to occur. In addition, in the hole portion 22, since the position on the outer side of the main body portion 21 with respect to the constricted portion 22d being the minimum diameter dimension position increases in diameter toward the opening 22c, the minimum diameter dimension portion positioned in the constricted portion 22d of the hole portion 22 of the anchor portion 32 is positioned on the inner side of the main body portion 21 with respect to the imaginary boundary surface B (FIGS. 2B and 2C). Therefore, in the composite component 10, it is difficult for the anchor portion 32 to break in the minimum diameter dimension position against external force in the shearing direction. As a result, in the composite component 10, a portion that can be broken when an excessive external force is applied can be limited to the metal portion 14 instead of the resin portion 15. In general, since setting the breaking position and its strength as calculated in the metal is easier than that in the resin, the portion which can be broken due to an excessive external force is limited to the metal portion 14 with the design described above, so that the fastening force between the metal portion 14 and the resin portion 15 can be set almost as designed based on the cross-sectional area of the metal portion 14, and the joining force can be stably obtained.

In addition, since the metal portion 14 and the resin portion 15 are formed so that the magnitude relation of cross sectional areas of the metal portion 14 and the resin portion 15 alternately changes in the joint portion (FIGS. 2A to 2C and 3A to 3C), a strong joining structure can be obtained.

Therefore, the metal portion 14 and the resin portion 15 generate a large joining force both in the tensile direction and in the shearing direction, and the joining strength of these can be improved.

In addition, the composite component 10 can be reduced in weight by forming a part with the resin portion 15.

In particular, applying the composite component 10 to a tubular component constituting a skeleton portion of a vehicle such as a steering hanger beam or a cross car beam being a cockpit module component of a vehicle such as an automobile allows the weight of the vehicle to be reduced, and the earthquake resistance and impact resistance to be improved.

Furthermore, connecting the hole portions 22 and 22 in each row of the hole portions 22 arranged in a plurality of rows to each other and the hole portions 22 and 22 in adjacent rows to each other inside the main body portion 21 with the connecting portion 23 allows continuous anchor portions 32 in the position of the connecting portion 23 to be continued over a plurality of hole portions 22 in rows and hole portions 22 in the adjacent rows, and the joining strength between the metal portion 14 and the resin portion 15 to be further improved.

In particular, in the present embodiment, forming a plurality of rows of the hole portions 22 in the direction of this row (predetermined one direction) without being displaced, that is, arranging the hole portions 22 in a rectangular lattice shape, and connecting a plurality of hole portions 22 in a rectangular lattice shape with the connecting portion 23 allows the material strength of the resin portion 15 to be relatively increased, and the fluidity of the molten resin to the hole portion 22 during molding of the resin portion 15 to be improved.

As in the second embodiment shown in FIG. 8, in a plurality of hole portions 22, each row of the plurality of rows of the hole portions 22 may be formed to be shifted from each other in the direction of the row (predetermined one direction), the hole portions 22 may be arranged in a zigzag shape (triangular lattice shape (regular triangular lattice shape))(triangular lattice form (regular triangular lattice form)) arranged in a zigzag shape with respect to another predetermined direction, and the plurality of hole portions 22 may be connected in a parallel lattice shape with the connecting portion 23 (imaginary line in FIG. 8). That is, the direction of the connecting portion 23 may be formed along the direction in which the molten resin flows into the hole portion 22. In this case, as compared with the first embodiment, the material strength of the metal portion 14 can be relatively increased.

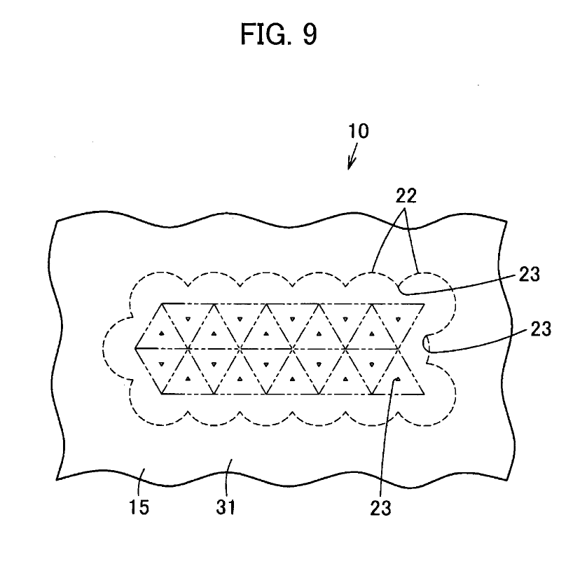

In addition, as in the third embodiment shown in FIG. 9, for example, a plurality of rows of the hole portion 22 may be formed to be shifted from each other in the direction of this row (one direction), the hole portions 22 may be formed in a zigzag shape (triangular lattice shape (regular triangular lattice shape)), and the plurality of hole portions 22 may be connected in a triangular lattice (regular triangular lattice) with the connecting portion 23 (imaginary line in FIG. 9). In this case, as compared with the above embodiments, the material strength of the metal portion 14 can be further relatively increased.

That is, as in the above embodiments, changing the arrangement of the rows of the hole portions 22 and the connection part of the hole portions 22 with the connecting portion 23 allows the balance between the material strength of the metal portion 14, the material strength of the resin portion 15, and the fluidity of the molten resin constituting the resin portion 15 to the hole portion 22 (ease of molding the resin portion 15) to be optionally set. Therefore, depending on various properties such as the material used for the metal portion 14, the material used for the resin portion 15, and the joining strength between the metal portion 14 and the resin portion 15 required for the composite component 10, a joining structure suitable for them can be set. In addition, these can be easily controlled simply by slightly changing the processing position during machining each hole portion 22 to change the arrangement of the hole portions 22.

In addition, in each of the above-described embodiments, the plurality of hole portions 22 may be formed in the main body portion 21 along directions separating from each other from the outside toward the inside of the main body portion 21. That is, the plurality of hole portions 22 may be formed in a radial shape when viewed from the outside of the main body portion 21. At this time, for example, the hole portions 22 in rows may be formed along directions separating from each other from the outside toward the inside of the main body portion 21, and the hole portions 22 in adjacent rows may be parallel to each other, or the respective hole portions 22 in rows and hole portions 22 in the adjacent rows may be formed along directions separating from each other from the outside toward the inside of the main body portion 21. Also in this case, the same action and effect as those of each of the above-described embodiments can be achieved, and for example, no force acts on the anchor portion 32 filled in the hole portion 22 in directions in which the protruding portions 34 and 34 are separated from each other by the tensile force in a direction in which the resin portion 15 separates from the metal portion 14, and the anchoring effect on the tensile force increases.

That is, the plurality of hole portions 22 only have to be provided along any one of the directions separating from each other and the directions parallel to each other from the outside toward the inside in the main body portion 21.

In addition, the connecting portion 23 may be configured so as to connect the hole portions 22 in rows to each other inside the main body portion 21, and so as not to connect the adjacent hole portions 22 to each other. Also in this case, the same action and effect as those of each of the above-described embodiments can be achieved, and for example, the continuous anchor portions 32 in the position of the connecting portion 23 can be continued over the plurality of hole portions 22 in rows, and the joining strength between the metal portion 14 and the resin portion 15 can be further improved.

In addition, the connecting portion 23 only has to connect at least two hole portions 22. Therefore, the anchor portions 32 only have to be connected to each other in the position of at least two hole portions 22.

Furthermore, for example, also in the case of joining metallic tube bodies as the metal portion 14, each of the above embodiments can be used.

For example, one end portion of one tube body to be joined is expanded to a diameter larger than the diameter of one end portion of the other tube body, the hole portion 22 and the connecting portion 23 are formed on an inner surface of the one end portion of one tube body and an outer surface of the one end portion of the other tube body to be inserted into the one end portion of the one tube body, and resin is filled in a gap between the one end portion of the one tube body and the one end portion of the other tube body. The resin filled in this way enters the hole portion 22 and the connecting portion 23 formed in each tube body to form the resin portion 15, thereby generating the anchoring effect, so that the resin can generate joining forces against the rotation direction and the removal direction of the tubular bodies. In this case, for example, in reducing the weight of the composite component 10 such as the steering hanger beam, it is possible to form and join the resin portion 15 in the same process as the molding process of the bracket or the like, rather than to outsert-join brackets or the like separately molded to the tube body part. Thus, since the tube bodies are physically joining structure via the resin portion 15, as compared with, for example, a case of joining by simply filling a thermosetting resin or the like between one end portion of one tube body and one end portion of the other tube body and joining with frictional force of resin or joining force of an adhesive system, there is little influence of compatibility (adhesion) between metal and resin, conditions during production, and the like, the state of the joining structure is stabilized, and the necessary strength can be predicted by the design shape. In addition, when the hole portion 22 is formed by irradiating the inner surface of one tube body with a laser beam, even if the hole portion 22 is shaped to be inclined toward one end portion of the tube body, as in each of the above embodiments, making a shape where the joint portion 32 is continuous in the position of the connecting portion 23 allows the joining force to be secured. Furthermore, the degree of freedom for selecting the resin material is high, and it is also possible to select a resin containing a filler in order to increase the joining strength.

In addition, for example, when flat plates are used as the metal portion 14 and the resin portion 15, turning may occur from the joining end portion on the resin portion 15 side against a tensile load not less than the allowable amount. Normally, this turning causes the anchor removal to occur in the joining end portion, and the resin breakage due to shearing occurs in the root end portion on the opposite side, but the anchor removal first starts in the joining end portion, whereby there are cases where the anchor of the joint portion is removed without shearing until it reaches the root end portion, and the joining strength is not stabilized. Therefore, for example, applying the normal anchor structure filled with resin into the hole portion 22 not connected with the connecting portion 23 having larger shear strength than the removal resistance in the center portion and the root end portion of the joining region where shear peeling is likely to occur while applying the structure of each of the above embodiments to the outer edge end portion of the joining region makes it difficult for removal to occur from the joining end portion and makes the central portion and the root end portion of the joining region strong against shearing, so that the strength can be improved efficiently. That is, applying the portion using the structure of each of the above embodiments and the portion using another structure according to the peeling mode depending on the position allows the anchoring effect to be further improved even during the joining of flat plates, and a strong joining force to be generated on various components.

Furthermore, the composite component 10 may be used as an optional structure or the like besides the structure used for a vehicle structure.

The present invention can be suitably used, for example, as a vehicle structure.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A composite component comprising:
a metal portion formed of a metal, the metal portion including:
a main body portion,
a plurality of hole portions provided along any one of directions separating from each other and directions parallel to each other in the main body portion from outside toward inside, and
a connecting portion configured to connect the hole portions to each other inside the main body portion; and
a resin portion formed of a resin, the resin portion including:
a cover portion covering the main body portion in a position corresponding to at least the plurality of hole portions, and
a joint portion provided in a protruding manner from the cover portion to be positioned inside the plurality of hole portions, the joint portion being continuous in a position of the connecting portion.

2. The composite component according to claim 1,
wherein the plurality of hole portions are arranged in rows,
wherein the connecting portion connects hole portions in rows to each other inside the main body portion, and
wherein the joint portion is continuous in a position of the connecting portion.

3. The composite component according to claim 1,
wherein the plurality of hole portions are arranged in a plurality of rows,
wherein the connecting portion connects hole portions in each row to each other and hole portions in adjacent rows to each other inside the main body portion, and
wherein the joint portion is continuous in a position of the connecting portion.
